(19) United States
(12) Patent Application Publication
(10) Pub. No.: US 2018/0288727 A1
(43) Pub. Date: Oct. 4, 2018

(54) Wireless Beacon Location System for Sensors and Indicators

(71) Applicant: Rocco D. Pochy, Milpitas, CA (US)

(72) Inventor: Rocco D. Pochy, Milpitas, CA (US)

(21) Appl. No.: 15/479,027

(22) Filed: Apr. 4, 2017

(51) Int. Cl. H04W 64/00; H04W 4/00; G01S 5/14; G01S 5/02

(52) U.S. Cl. CPC H04W 64/003; G01S 5/0226; G01S 5/14; H04W 4/008

(57) ABSTRACT

A method and system designed to verify and protect the location-specific data acquired in measurements performed with a precise instrument is described. The system preferably employs Bluetooth radios as a means to identify distance based on signal strength, which act as beacons during measurements taken with integrated instruments. Data recorded is attributed to the precise location data acquired via the system, and is updated if movement of the measured material is performed.

### FIELD OF THE PRESENT INVENTION

The present invention relates generally to systems and methods configured to identify the location of measurement data acquired via a measuring device in a monitoring environment, and more specifically relates to a system of wireless beacons or broadcasting tags which facilitate the automatic updating of the source location of the data as the measurement device changes location.

### BACKGROUND OF THE PRESENT INVENTION

In the process of creating semiconductors, particle counters are used to aid in the establishment of a closed environment. As is the case with all devices, there comes a time to replace or calibrate these particle counting devices. Several problems can arise when these instruments are moved out of their physical location. A common way to identify a machine is to use a device address, showing that device A belongs in room A, device B in room B, etc. This way, when reporting on particle contamination, it is easy to identify the amount of particles coming from each specific room. A problem with this method arises when machines are moved and then replaced in the wrong location. If a particle counting device is labeled at one location but then placed in a different location, it will yield incorrect results to an inspector. Particle contamination problems will not be correctly addressed if the source data for the contamination is inaccurate.

With some instruments, the need to repeatedly take measurements at several locations is required or mandated. The usual method for using such instruments is to place the instrument at a pre-defined location, enter the location into the instrument, and then collect the data. The problem with this is the demand for the operator to update the location at which the data is collected before each use so that the data is mapped to the correct location. This method is not only inconvenient, but allows many opportunities for user error.

Similarly, the need exists in other markets to take multiple measurements at several locations, often within a warehouse, pharmaceutical facility, or hospital. In such measured environments, it is critical to associate the measured data with the correct location, and often to observe measurements according to location-specific criteria. Presently, few options are available on the market that enable a measuring device to dynamically adjust measurements taken according to location-sensitive survey protocols.

Thus, there is a need for a sensor/indicator system that allows machines/sensor instruments to be moved, placed in a different location, and automatically updated with the new location of where the data is being collected. Using a tag that broadcast information on the location and its state allows the instrument to record and update how the information is collected and stored. This is an improvement over previous inventions that merely record a unique tag value for location in question. By using a tag at each pre-defined location and a reader built into the instrument, this process mitigate risk due to human error to assure accurate recording of data at the locations prescribed.

### SUMMARY OF THE PRESENT INVENTION

The present invention is a system for allowing a particle counting device or other precise measuring device to automatically update its data source when it is removed from one location and replaced in a new location. The present invention includes a broadcasting tag that is placed at the location of interest, as well as a receiving sensor that is placed on the particle counter (or other measuring device) itself. The receiving sensor is configured to detect the presence of the broadcasting tag (based on signal strength, location ID, and other parameters associated with the tag and the specific location) which would allow the particle counter or other measuring instrument the ability to note its location and activate actions associated that specific location. An observer will be assured that the particle-counting device or similar data collection instrument is truly reporting from the stated location.

The preferred embodiment of the current invention employs Bluetooth tags which are placed at the locations of interest, and Bluetooth readers built into the instrument. Bluetooth technology is preferably used due to its extreme popularity and low cost of implementation. Bluetooth transmitters and receivers are widely available, and are now at a low cost. However, alternately, it is envisioned that other wireless interfaces could be employed and configured to function with the system of the present invention. For example, NFC (Near Field Communication) may be used with some embodiments of the present invention.

In short, the present invention is a system for protecting the precise calibration of location data, designed to ensure that all measurements made with an instrument are associated with the correct location—even in the event that the location has changed. It is crucial that the location data is kept correct in order to provide an accurate indication of the state of the area. Additionally, the system of the present invention facilitates correction or augmentation of the measuring instrument according to location-specific parameters which are authenticated via the location detection mechanisms of the present invention.

### BRIEF DESCRIPTION OF THE DRAWINGS

The present invention will be better understood with reference to the appended drawing sheets, wherein:

FIG. 1 displays a flow chart depicting the process of use of the present invention.

FIG. 2 exhibits a flow chart of an alternate embodiment of the present invention, detailing an alternate usage case.

FIG. 3 shows a diagram of the components of the present invention, and how they interact during use.

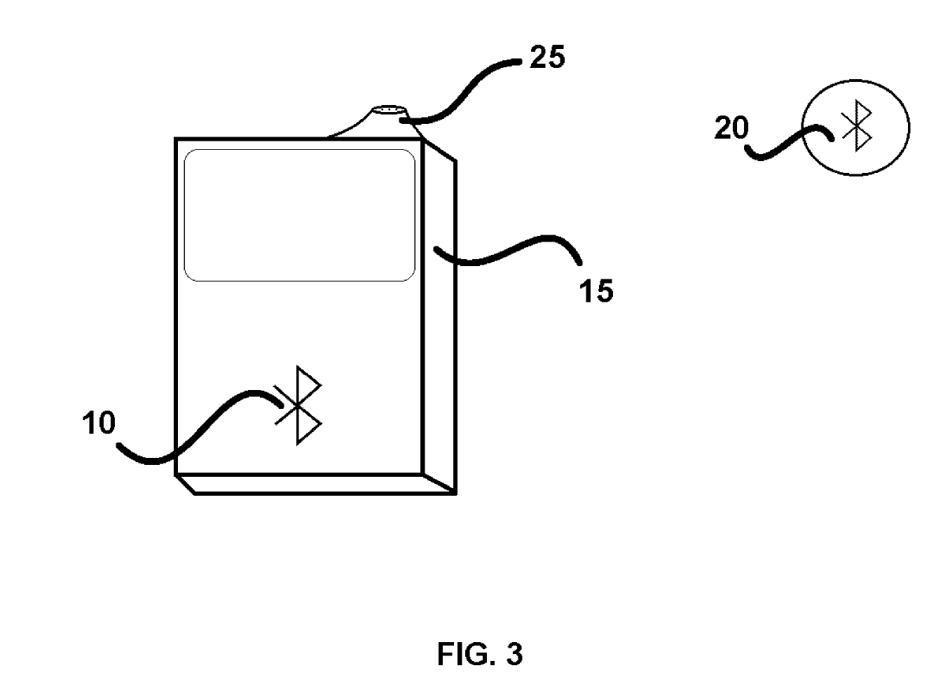

### DETAILED DESCRIPTION OF THE PREFERRED EMBODIMENT

The present invention is a protection system for calibrated instruments that are designed to gather data from measurements taken at location-sensitive positions. As such, the present invention employs the use of a Bluetooth™ receiving sensor (10) incorporated into an instrument (15) in order to assign a location to a broadcasting tag (20), otherwise referred to as a beacon, for tracking and monitoring purposes of data acquired at that location.

A data collection instrument (15) equipped with the present invention contains a conventional Bluetooth receiving sensor (10), otherwise referred to as a Bluetooth reader. When the instrument (15) is used to take a measurement via at least one sensor (25), a Bluetooth broadcasting tag (20) is read by the Bluetooth receiving sensor (10) at the location the measurement is taken at. The instrument (15) then assigns the measurement, such as a particle count, to the location, and associates it with the broadcasting tag (20) number located proximal to the location of measurement. It is the intent of the present invention to ensure data that is gathered via a sensor is mapped to the correct location, regardless of if the broadcasting tag location is changed. As such, the present invention enables the instrument (15) to be spatially aware, and can facilitate accurate placement of the measurement data within a specified space within a location such as a room.

Ted implementation of the system of the present invention is the use of Bluetooth broadcasting tags (20), which are placed at the locations of interest—places from where sensory data is desired. Bluetooth receivers (10) are preferably built into the instrument (15). When the instrument (15) is placed within the range of the broadcasting tag (20), the reader reads the location of the tag, preferably either by its association with a location within a grid, GPS, or other sensitive indoor location technology, and updates the location information with the data collected. Moving or replacing sensors would allow automatic updates of the location of where the data is being collected, in real time. In this manner, the precise location of the broadcasting tag (20), as well as the corresponding measurements taken at the position of the broadcasting tag (20), are kept up-to-date, even if the broadcasting tag (20) is moved. This is because the location of the broadcasting tag (20) is updated each time it is accessed or read by the Bluetooth reader (10) equipped by the instrument taking measurements.

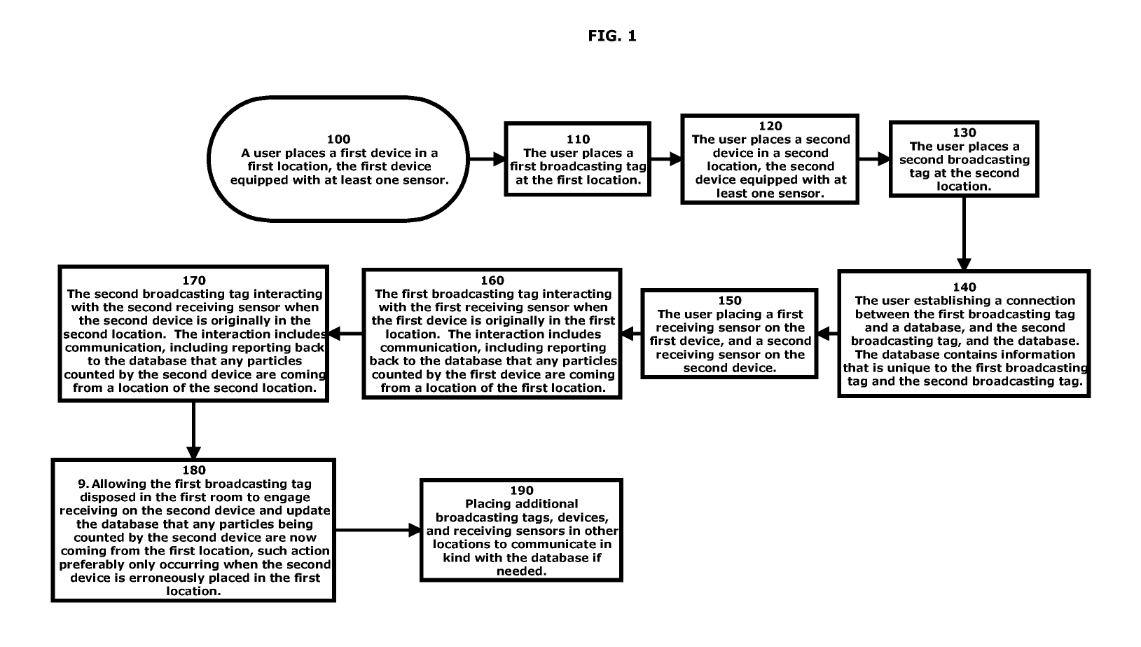

The process of use of the present invention, as depicted in FIG. 1, is preferably as follows:
1. A user places a first device in a first location, the first device equipped with at least one sensor. (100)
2. The user places a first broadcasting tag at the first location. (110)
3. The user places a second device in a second location, the second device equipped with at least one sensor. (120) It should be noted that the first location and the second location may be disposed within different rooms, or within the same room.
4. The user places a second broadcasting tag at the second location. (130)
5. The user establishing a connection between the first broadcasting tag and a database, and the second broadcasting tag, and the database. The database contains information that is unique to the first broadcasting tag and the second broadcasting tag. (140)
6. The user placing a first receiving sensor on the first device, and a second receiving sensor on the second device. (150)
7. The first broadcasting tag interacting with the first receiving sensor when the first device is originally in the first location. The interaction includes communication, including reporting back to the database that any particles counted by the first device are coming from a location of the first location. (160)
8. The second broadcasting tag interacting with the second receiving sensor when the second device is originally in the second location. The interaction includes communication, including reporting back to the database that any particles counted by the second device are coming from a location of the second location. (170)
9. Allowing the first broadcasting tag disposed in the first room to engage receiving on the second device and update the database that any particles being counted by the second device are now coming from the first location, such action preferably only occurring when the second device is erroneously placed in the first location. (180)
10. Placing additional broadcasting tags, devices, and receiving sensors in other locations to communicate in kind with the database if needed. (190)

It should be understood that the broadcasting tags of the present invention may be any form of intelligent broadcast tag, including those that are Bluetooth™ based and/or NFC based, and are used as a means to assign a location, as well as location specific configurations to a device (such as a sensor or indicator), such that the data collected is properly tagged with the correct location, and is collected by a configuration that is specific to that location. It is envisioned that the present invention is not limited in scope to particle counters, but may be employed and/or integrated within other environmental sensors and indicators in a monitored environment.

It should be understood that the present invention employs this beacon technology with the capacity to gauge precise distance based on the signal strength inferred by the Bluetooth receiver (10) of the measuring device (instrument), which is equipped to detect the signal of the Bluetooth broadcasting tag, and gauge distance according to the strength of the returned signal. Signal strength data may be added to the known physical location of the broadcasting tag in order to attain even more precise location data to be attributed to measurements taken at that location.

Embodiments of the present invention that are equipped with only one instrument and only a single broadcasting tag (20) are configured to only accept an instrument reading as valid if it is verified to have been taken by the instrument (15) within range of the broadcasting tag (10). For instance, if a user conducts a reading with the instrument while not within range of the Bluetooth broadcasting tag (10), the results of the reading (data) is considered invalid automatically.

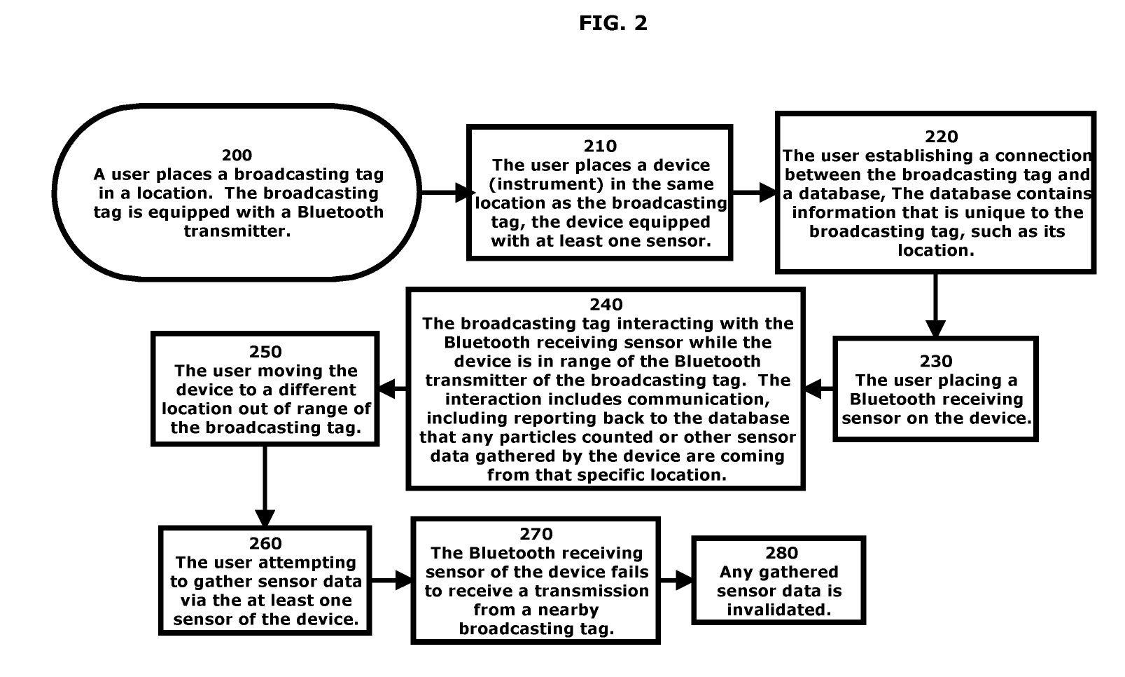

FIG. 2 depicts a flow chart detailing such an example in which only one broadcasting tag (20) is present. As shown, the instrument may gather sensor data accordingly, but without verification from the broadcasting tag (20), the data collected is rendered invalid without location verification, and the data is not recorded. This is a simplified embodiment of the present invention, however the resulting verification and correlation of sensor data to location remains consistent in all embodiments of the present invention.

This simplified, single broadcasting tag (20) embodiment, as seen in FIG. 2, is as follows:
1. A user places a broadcasting tag in a location. The broadcasting tag is equipped with a Bluetooth transmitter. (200)
2. The user places a device (instrument) in the same location as the broadcasting tag, the device is equipped with at least one sensor. (210)
3. The use establishes a connection between the broadcasting tag and a database, the database containing information that is unique to the broadcasting tag, such as its location. (220)
4. The user placing a Bluetooth receiving sensor on the device. (230)
5. The broadcasting tag interacting with the Bluetooth receiving sensor while the device is in range of the Bluetooth transmitter of the broadcasting tag. The interaction includes communication, including reporting back to the database that any particles counted or other sensor data gathered by the device are coming from that specific location. (240)
6. The user moving the device to a different location out of range of the broadcasting tag. (250)
7. The user attempting to gather sensor data via the at least one sensor of the device. (260)
8. The Bluetooth receiving sensor of the device fails to receive a transmission from a nearby broadcasting tag. (270)
9. Any gathered sensor data (obtained via the at least one sensor of the device) is invalidated. (280)

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

We claim:

1. A method for identifying locations of sensors and indicators comprising:
placing broadcasting tags at one or more unique locations;
wherein the broadcasting tags are equipped with Bluetooth transmitters, each broadcasting tag having a unique broadcasting number;
configuring the broadcasting tags with a database to map the unique broadcasting number of each broadcasting tag to a unique location;
placing an instrument within range of a broadcasting tag;
wherein the instrument is equipped with a Bluetooth receiver;
wherein the instrument is equipped with at least one sensor;
the broadcasting tag communicating the unique broadcasting number to the Bluetooth receiver of the instrument at a given location; and
the instrument recording the location information per the unique broadcasting number along with any data collected at that location via the at least one sensor.

2. The method of claim 1, further comprising:
placing the instrument out of range of a broadcasting tag;
the instrument recording data via the at least one sensor; and
the instrument regarding the data as invalid.

3. The method of claim 1, wherein the instrument is portable; and
wherein broadcasting tags are fixed in position.

4. A method for automatically verifying the originating location of environmental data acquired by sensors comprising:
placing broadcasting tags at fixed locations;
wherein the broadcasting tags are equipped with a Bluetooth transmitter;
associating the broadcasting tags with their corresponding locations by at least one instrument;
wherein the at least one instrument is equipped with sensors configured to collect measurements;
placing the at least one instrument at a first location within range of a broadcasting tag;
taking a measurement with the at least one instrument at the first location, creating first measurement data;
the at least one instrument attributing the first measurement data to the first location obtained via signal strength from the Bluetooth transmitter of the broadcasting tag disposed at the first location;
placing the at least one instrument at a second location within range of a broadcasting tag;
taking a measurement with the at least one instrument at the second location, creating second measurement data; and
the at least one instrument attributing the second measurement data to the second location obtained via signal strength from the Bluetooth transmitter of the broadcasting tag disposed at the second location.

5. The method of claim 4, wherein broadcasting tags are fixed in position; and
wherein the at least one instrument is portable.

6. A method for identifying locations of sensors and indicators, comprising:
placing a first device at a first location;
placing a second device at a second location;
placing a first broadcasting tag in the first location;
placing a second broadcasting tag in the second location;
configuring the first broadcasting tag and the second broadcasting tag to communicate with a database, the database containing information unique to the first broadcasting tag and the second broadcasting tag;
placing a first receiving sensor on the first device;
placing a second receiving sensor on the second device;
communicating between the first broadcasting tag and the first receiving sensor when the first device is originally in the first location, such communication including reporting back to the database that any environmental data logged by the first device are coming from a location of the first location;
communicating between the second broadcasting tag and the second receiving sensor when the second device is originally in the second location, such communication including reporting back to the database that second location;
allowing the second broadcasting tag in the second location to engage receiving on the first device and update the database that any environmental data logged by the first device are now coming from the second location, such action occurring when the first device is erroneously placed in the second location;
allowing the first broadcasting tag in the first location to engage receiving on the second device and update the database that any environmental data logged by the second device are now coming from the first location, such action occurring when the second device is erroneously placed in the first location;
providing at least one foot of space between the first device and the second;
allowing for additional broadcasting tag, additional devices, and additional receiving sensors to be placed into respective locations and to communicate with the database;
positioning broadcasting tags into the first location, the second location and the respective location in fixed positions;
engaging the first broadcasting tags, the second broadcasting tags and the additional broadcasting tags placed in the first location, the second location and the respective position to determine in which locations the first device, the second device and the additional devices are located;
transmitting data to the database via data streams from the first device, the second device and the additional devices, the data streams containing information from the first device, the second device and the additional devices; and
informing the first broadcasting tag, the second broadcasting tag and the additional broadcasting tag a location of the first broadcasting tag, the second broadcasting tag and the additional broadcasting tag, followed by sending the data stream to the database.

7. The system of claim 6, further comprising:
preventing the first device and the second device from erroneously detecting the second broadcasting tag and the first broadcasting tag, respectively, when the first device and the second device should actually be detecting the first broadcasting tag and the second broadcasting tag.

8. The system of claim 6, further comprising mounting the first receiving sensor to the first device.

9. The system of claim 8, further comprising mounting the second receiving sensor to the second device.

10. The system of claim 6, further comprising mounting the first broadcasting tag in a fixed position in the first location.

11. The system of claim 6, further comprising mounting the second broadcasting ag in a fixed position in the second location.

12. The system of claim 6, further comprising employing a Bluetooth transmitter to interface with said first broadcasting tag and said second broadcasting tag to attain location data; and
attributing the location data to the data stream.

13. The system of claim 6, further comprising communicating data between the database and a server.

14. A system for attributing location data to measured quantitative environmental data in real-time comprising:
a measuring device, said measuring device configured to measure quantitative data;
a Bluetooth receiver, said Bluetooth receiver disposed on said measuring device;
a first broadcasting tag, said first broadcasting tag disposed at a first location;
a second broadcasting tag, said first broadcasting tag disposed at a second location;
a server, said server housing a database;
wherein said measuring device is configured to relay said quantitative data to said database;
wherein said first broadcasting tag indicates a first location to said measuring device via said Bluetooth receiver;
wherein said measuring device attributes said first location to said quantitative data obtained at said first location;
wherein said second broadcasting tag indicates a second location to said measuring device via said Bluetooth receiver; and
wherein said measuring device attributes said second location to said quantitative data obtained at said second location.
